(19) United States
(12) Patent Application Publication
(10) Pub. No.: US 2010/0072813 A1
(43) Pub. Date: Mar. 25, 2010

(54) Crawler Tracks and Idlers for Crawler Tracks

(76) Inventors: Brian Donald McRae, Withcott (AU); Arthur Reginald McNae, Ormeau (AU)

Correspondence Address: WELLS ST. JOHN P.S., 601 W. FIRST AVENUE, SUITE 1300, SPOKANE, WA, 99201, US

(21) Appl. No.: 12/242,513

(22) Filed: Sep. 30, 2008

Related U.S. Application Data
(63) Continuation-in-part of application No. 11/715,083, filed on Mar. 6, 2007.

(30) Foreign Application Priority Data
Jan. 16, 2007 (AU) 2007200163
Mar. 5, 2007 (ZA) 2007/01918

(51) Int. Cl. B62D 55/00; B62D 55/14; B62D 55/08

(52) U.S. Cl. 305/120; 305/125; 305/194

(57) ABSTRACT

An idler for use on a tracked vehicle of the type having a track that includes a plurality of track links joined together, which track links pass around the idler. The idler includes a plurality of generally flat surfaces that come into contact with corresponding generally flat surfaces on the track links as the track links pass around the idler. Reduced wear results. The generally flat surfaces on the idler may be provided by removable wear plates.

This application is a continuation-in-part of U.S. Utility application Ser. No. 11/715,083 which was filed on Mar. 6, 2007, the entirety of which is incorporated by reference herein. The application claims benefit of 35 U.S.C. §120.

The present invention relates to crawler tracks and idlers for crawler tracks.

Many vehicles requiring high traction such as bulldozers, excavators, agricultural tractors, military tanks and armoured personnel carriers have crawler tracks instead of wheels.

Typically, each crawler track includes an endless track chain made up of track links which are held together by pins and bushes to allow up and down pivoting of adjacent links relative to each other when in use so that the chain can wrap around a drive sprocket which engages the pins (or bushes) so as to propel the track about a track frame. The track frame typically includes one or more idlers and in most cases other load carrying components or chain guidance components such as bogies, track rollers, and carrier rollers. Shoes or plates are bolted or otherwise secured to the links to provide the ground engaging surface of the crawler track. Commonly, larger machines have two spaced apart chains and the track shoes span the space between the chains and are secured to opposite links of both chains. In such cases, the idlers typically have two spaced apart cylindrical running faces on which the track links run.

The track links engage the idler and various other components on the track frame along their bottom faces as they run around and the links wear along those faces. In this respect, the bottom faces are initially flat and as the links run around the cylindrical running faces of the idler, the links wear in the mid portion of their bottom faces more than on their end portions thereby giving an arcuate wear pattern when seen from the side of the track. At the same time, the idlers wear from slippage of the links as the vehicle moves from forward to reverse and vice versa or turns one way or the other. Excessive arcuate wear on track links causes undesirable machine vibration which decreases their usable service life. Additionally, the wear causes the ride to be rougher than desired as the drive sprocket pulls the body of the vehicle over the tracks as they lie on the ground.

U.S. Pat. No. 6,536,853 attempts to reduce wear in the track links by providing an idler with peripheral notches arranged to engage the pins and bushes. However, such arrangement does have disadvantages.

One object of the present invention is to provide drive train components, particularly idlers which are less prone to wear or at least can be rebuilt to some extent with less downtime.

With the foregoing in view, the invention in one aspect resides broadly in an idler for use on a tracked vehicle of the type including a track chain of interconnected track links passing around the idler, the idler having a plurality of generally flat surfaces adapted to come into contact with corresponding generally flat surfaces on the track links as the track links pass around the idler.

Preferably, each of the plurality of flat surfaces on the idler have a length matching the link pitch of the track chain formed by the track links.

In another aspect, the invention resides broadly in a drive train for a tracked vehicle, the drive train including at least one drive sprocket, at least one idler and one or more track chains, each of said one or more track chains including a plurality of links pivotally connected to each other and adapted for engagement with said at least one drive sprocket and adapted to wrap around said at least one idler for movement therewith, at least one of said at least one idlers having a bore or hub for mounting the idler on a shaft for rotation relative thereto about the bore or hub axis and one or more chain supporting faces radially spaced from said bore or hub, the or each chain supporting face comprising a plurality of generally planar link supporting lands together forming a polygonal prismatic face coaxial with the hub axis, the link supporting lands being of substantially equal length in the circumferential direction and the bottom face of adjacent following links being arranged in use to engage adjacent lands of the same chain supporting face.

In another aspect, the invention resides broadly in an idler for a tracked vehicle, the idler having a bore or hub for mounting the idler on a shaft for rotation relative thereto about the bore or hub axis and one or more chain supporting faces radially spaced from said bore or hub, each chain supporting face comprising a plurality of generally planar link supporting lands together forming a polygonal prismatic face coaxial with the bore or hub axis, the link supporting lands being of substantially equal length in the circumferential direction and the angle enclosed by adjacent link supporting lands being greater than one hundred and twenty degrees.

Preferably, each link has a bottom contact face of a predetermined length and the length of each link supporting land is substantially the same as said predetermined length. Advantageously, selection of such length is believed to provide greater reduction in wear rate over other lengths. It is also preferred that the links be shaped such that as they wear the length of the bottom face increases. In one form, the ends of the links taper outwards away from the bottom face to achieve such effect. Advantageously, such links allow for rebuilding of the idler chain supporting faces to a greater length on a greater dedendum circle diameter so as to maintain the desired relationship between the bottom contact face of the links and the length of the link supporting lands. The term “dedendum circle diameter” is used herein to refer to the diameter of a circle centered on the hub axis and to which the lands are tangential at their respective mid-points in the circumferential direction. In a preferred form, the idler includes a plurality of detachable wear plates and the link supporting lands are formed on the detachable wear plates. In such form, as the bottom faces of the links wear, the wear plates can be removed and replaced by thicker wear plates having proportionately longer link supporting lands thus increasing the dedendum circle diameter of the lands. In one such form, the wear plates have a single generally planar wear face but in another form, the wear plates have two generally planar faces enclosing an angle therebetween greater than about one hundred and twenty degrees. Advantageously, in use, each such planar face is adapted to form a portion of a link supporting land such that the adjacent planar faces of two adjacent wear plates on the idler hub together form a full link supporting land corresponding approximately in length to the link pitch of the chain. Preferably, the wear plate is adapted to be secured to the idler hub by bolts or similar fasteners engaging each planar face. In a preferred form, each planar face forms about half the desired link supporting land length. Advantageously, such arrangement provides solid corners on the link supporting faces of the idler thereby avoiding gaps between wear plates at the point and reducing wear.

In another form, the wear plates have link guide lands generally orthogonal to the link supporting lands which are adapted to be engaged by the inside faces of the chain links. In such form, upon the link guide lands wearing beyond a desirable amount they can be replaced instead of having to replace the whole idler as in a case where the chain links engage the idler hub directly.

In yet another aspect, the invention resides broadly in a superset of wear plates for an idler, the superset including at least two sets of wear plates, the wear plates having a mounting face adapted to engage a supporting face of an idler hub to which the wear plates are to be attached and a chain link supporting land spaced from the mounting face, the distance between the mounting face and the chain link supporting land of the wear plates in a set being the same and the distance in at least one set being greater than the distance in another set, the increased distance being selected to compensate for wear in the track links which engage the wear plates when mounted to the same idler hub.

In still yet another aspect the invention resides broadly in the combination of an idler and a track chain, the idler having a hub or rim and a set of wear plates as previously described mounted thereto for engagement by the chain.

Preferably, the one or more track chains comprises two spaced apart chain halves with the corresponding links of said chain halves being aligned laterally and connected by pins and bushes adapted to engage the drive sprocket and the one or more chain supporting faces comprise two spaced apart chain supporting faces and one of said chain halves is adapted to engage with one chain supporting face and the other track chain is arranged to engage with the other chain supporting face. The terms “half” and “halves” are intended to refer to the chain on one side of a track in cases where two chains are normally used irrespective or whether such chain may be capable of acting as a chain by itself or not unless the context clearly indicates otherwise.

In order that the invention may be more easily understood and put into practical effect, reference will now be described with reference to the accompanying drawings wherein:

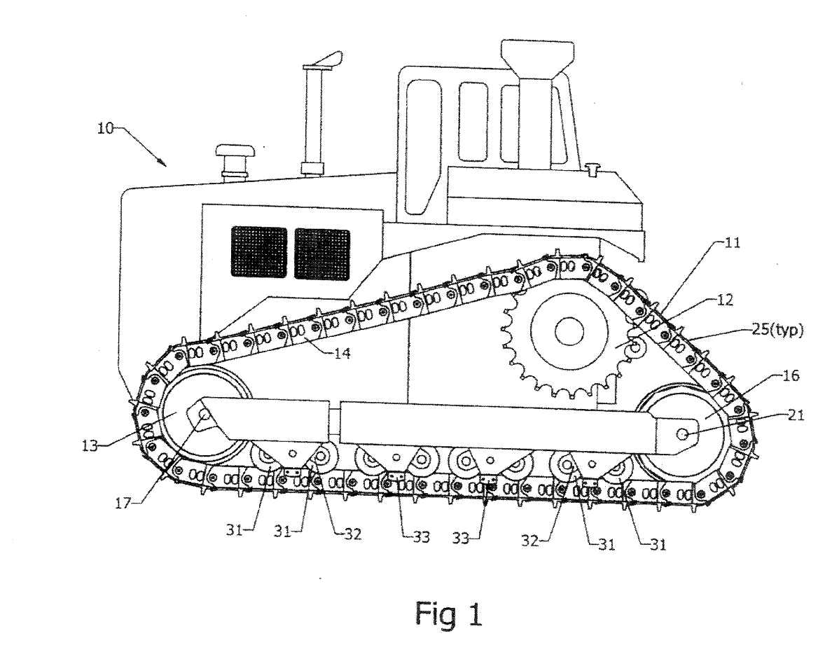

FIG. 1 is a side elevation of a bulldozer with a drive train incorporating a rear idler according to the invention;

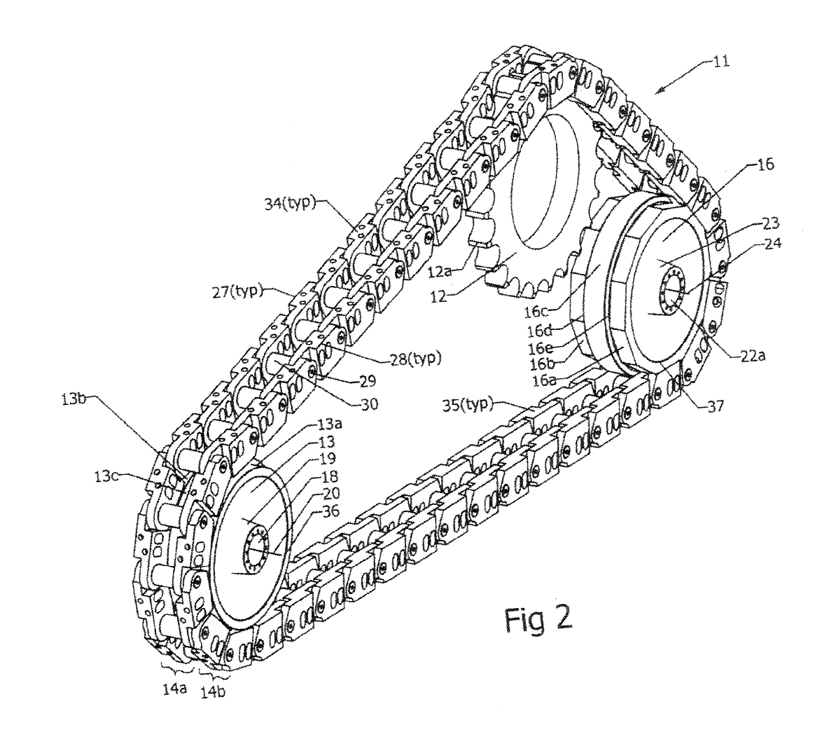

FIG. 2 is a pictorial representation of the drive train of the bulldozer of FIG. 1;

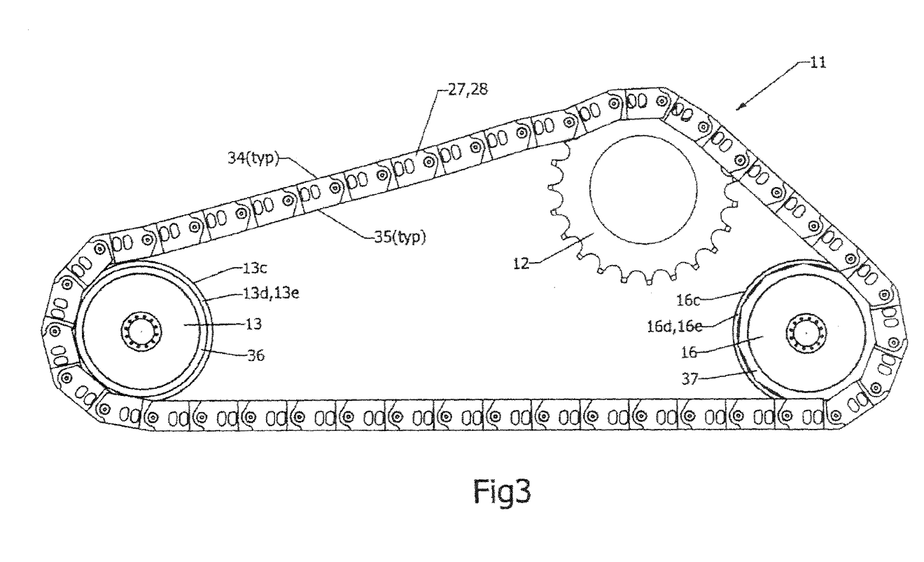

FIG. 3 is a side elevation of the drive train of FIG. 1;

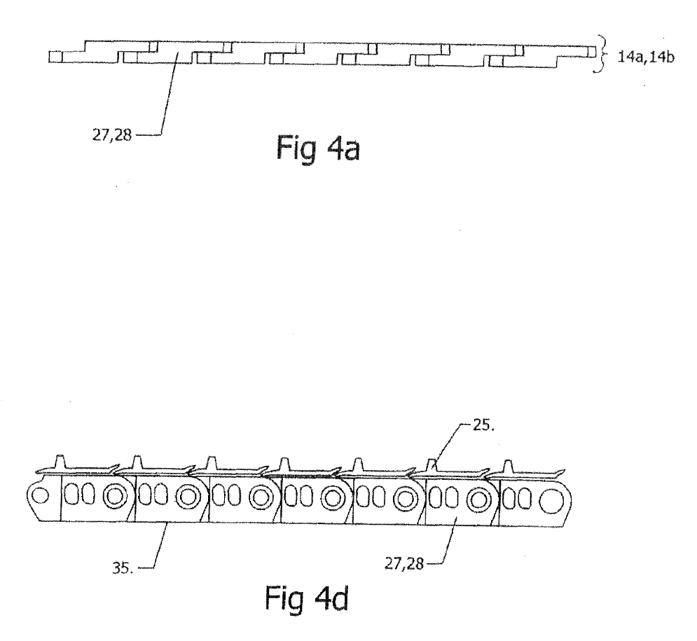

FIG. 4A is a schematic plan of the bottom of one of the track chains of the drive train of FIG. 2;

FIG. 4B is a plan of the track chains of the drive train of FIG. 2 with part shown in section along line 4b-4b;

FIG. 4C is a side elevation of a portion of the track chains of the drive train of FIG. 2;

FIG. 4D is a schematic side elevation of the track chains of the drive train of FIG. 2 with shoes (or plates) bolted to the links;

FIG. 4E is a schematic side elevation of a new chain link of one of the halves of the track chain of the drive train of FIG. 2;

FIG. 4F is a schematic side elevation of a worn chain link of one of the halves of the track chain of the drive train of FIG. 2;

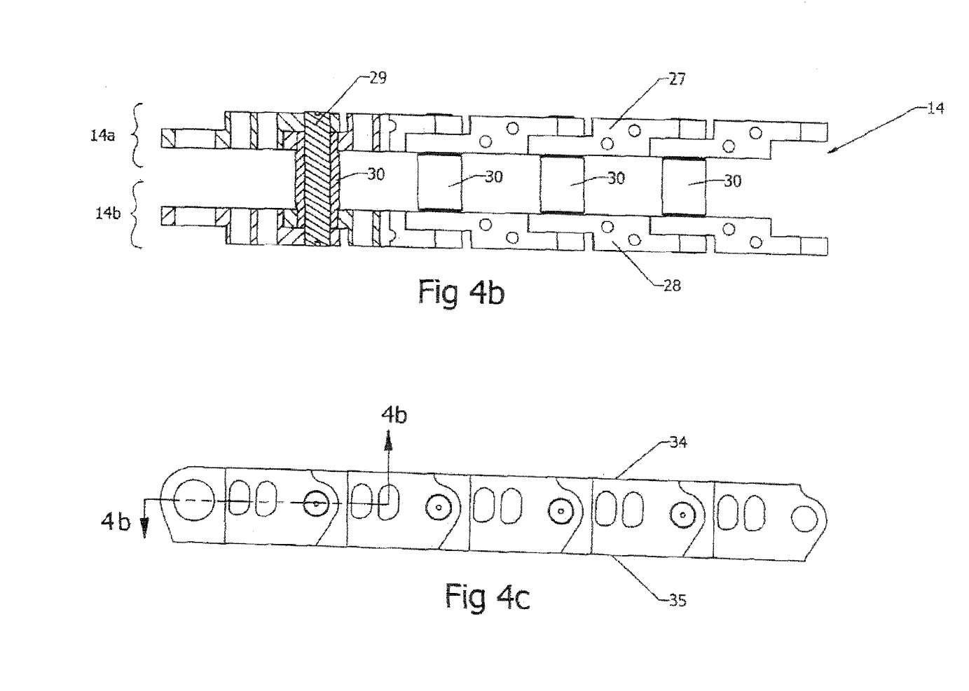

FIG. 5 is a schematic side elevation of one well known track arrangement used on tracked vehicles;

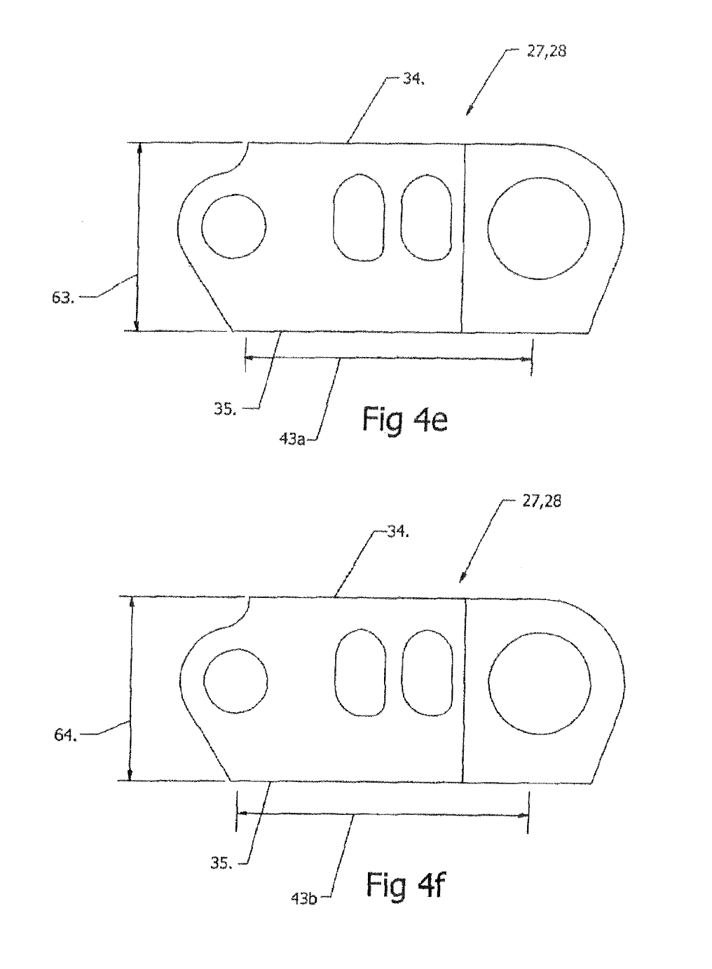

FIG. 6 is a schematic side elevation of another well known track arrangement used on tracked vehicles;

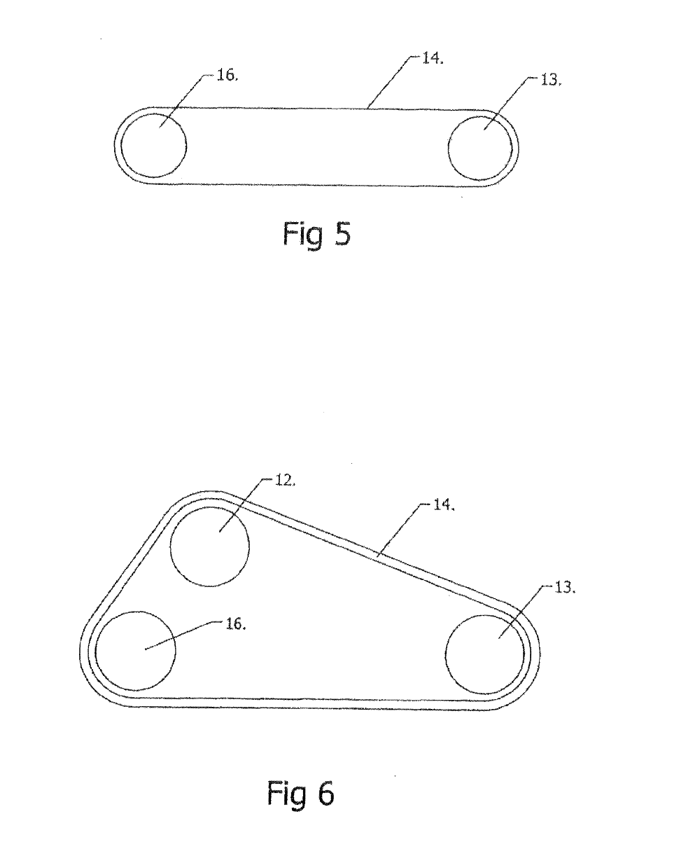

FIG. 7 is a pictorial representation of an idler according to the invention;

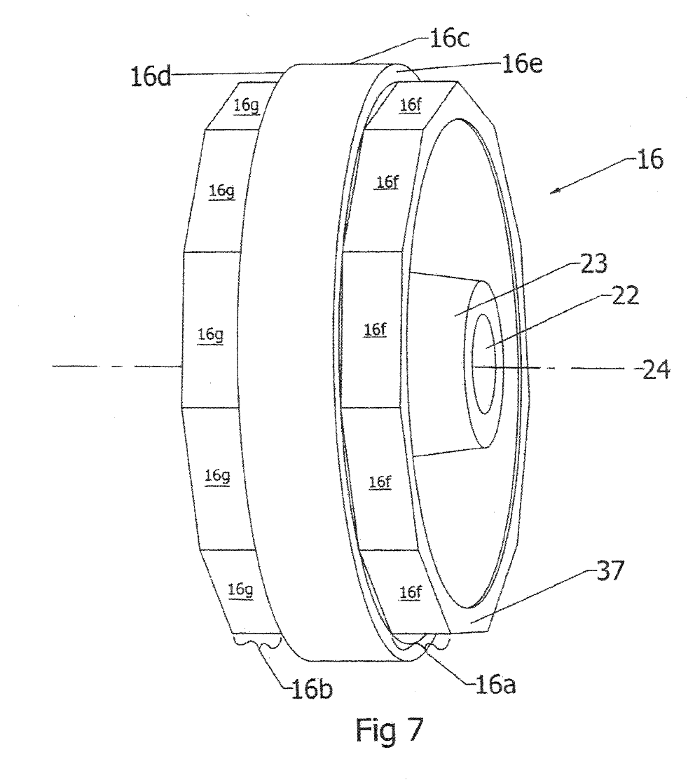

FIG. 8 is a side elevation of the idler of FIG. 7;

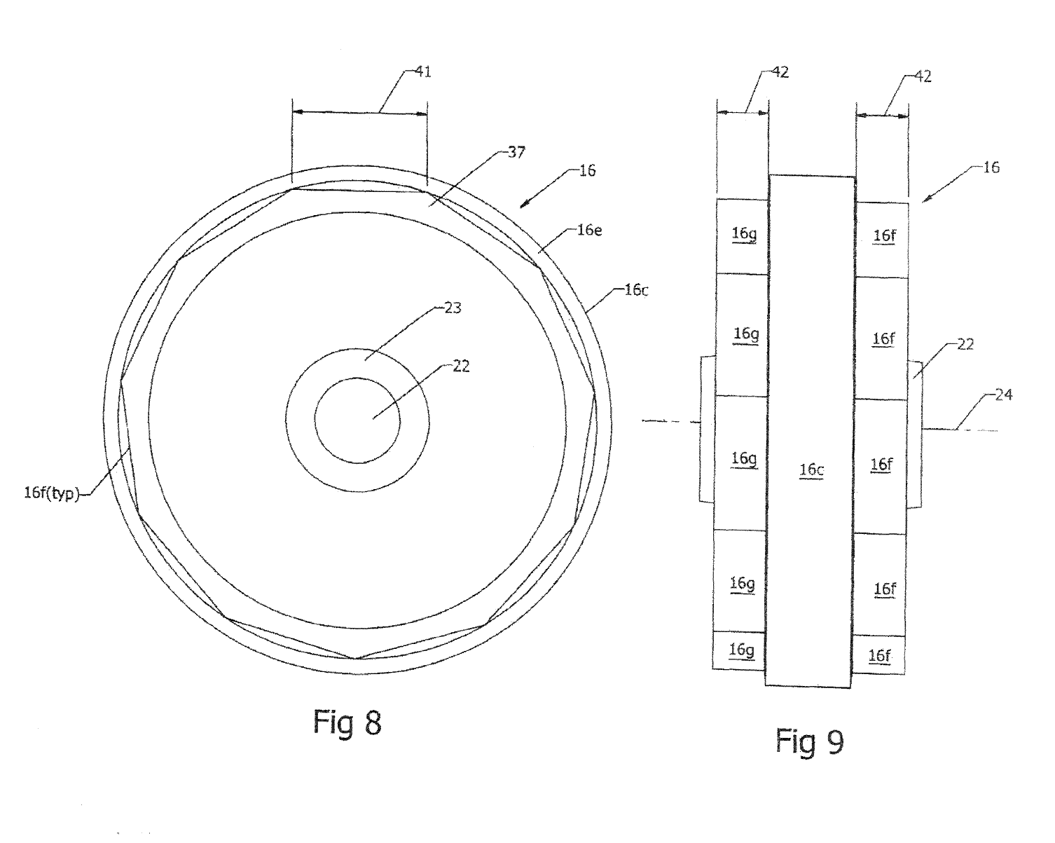

FIG. 9 is a front elevation of the idler of FIG. 7;

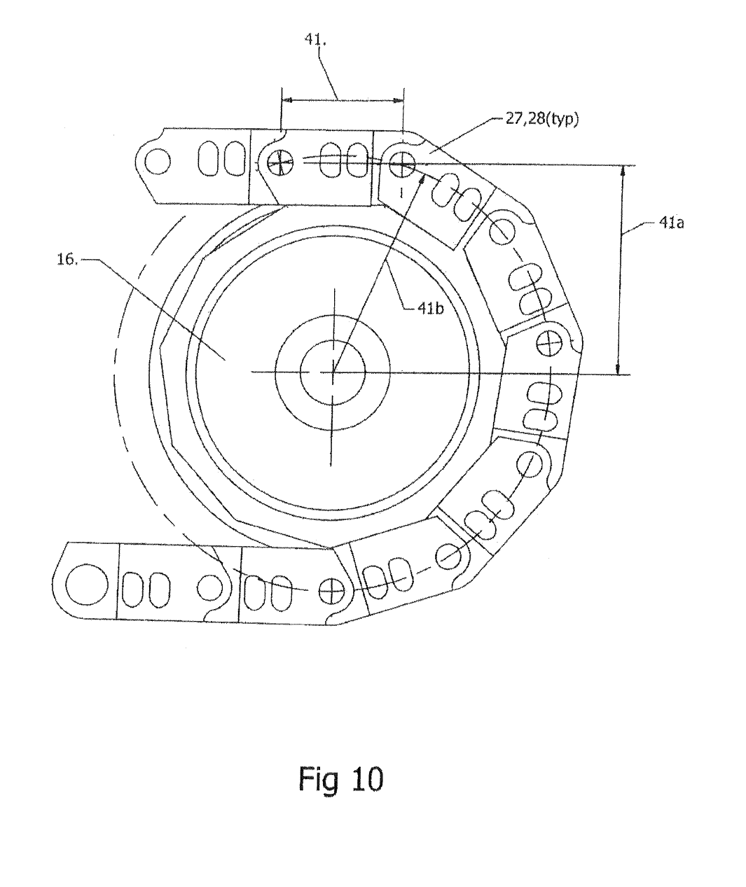

FIG. 10 is a side elevation of the idler of FIG. 7 with a track chain engaged therewith;

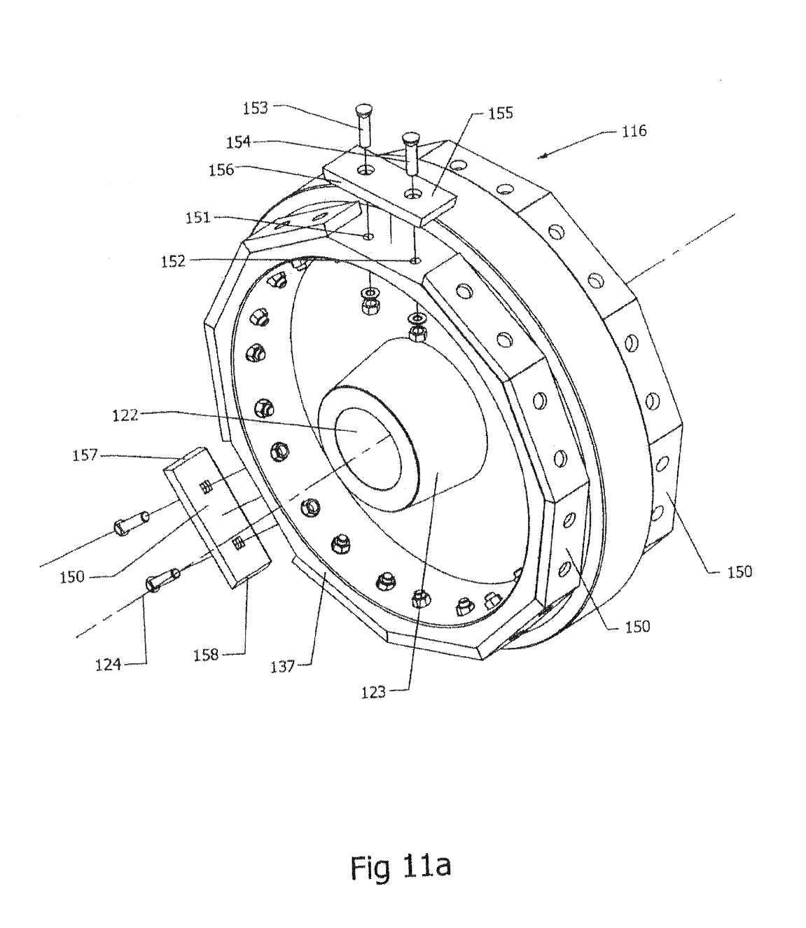

FIG. 11A is a pictorial representation of another idler according to the invention;

FIG. 11B is an elevation of the idler of FIG. 11A with a track chain engaged therewith;

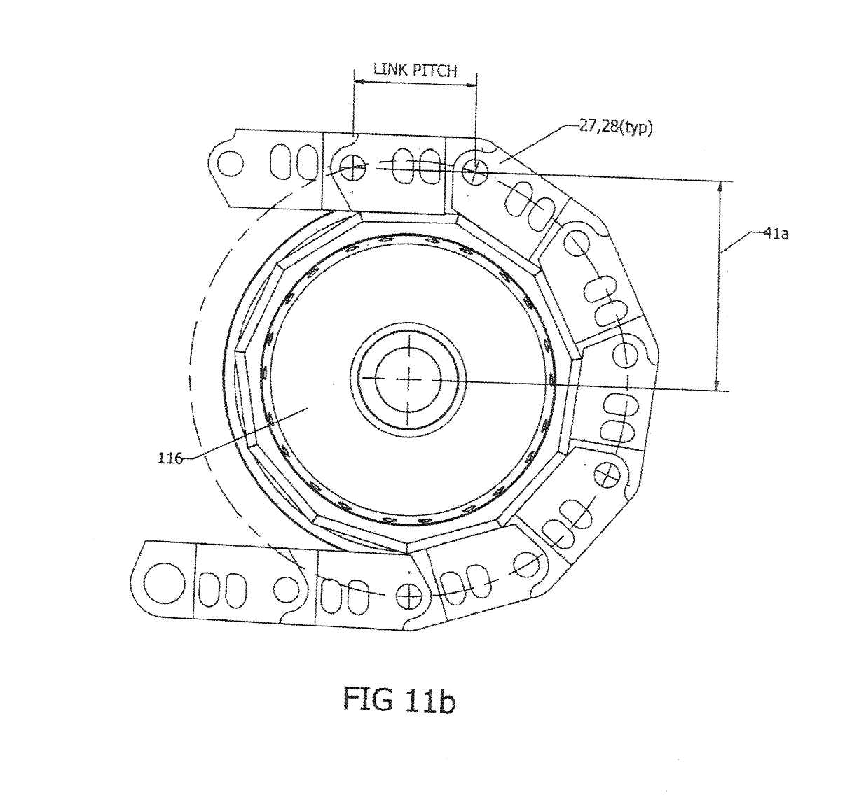

FIG. 12 is a pictorial representation of yet another idler according to the invention;

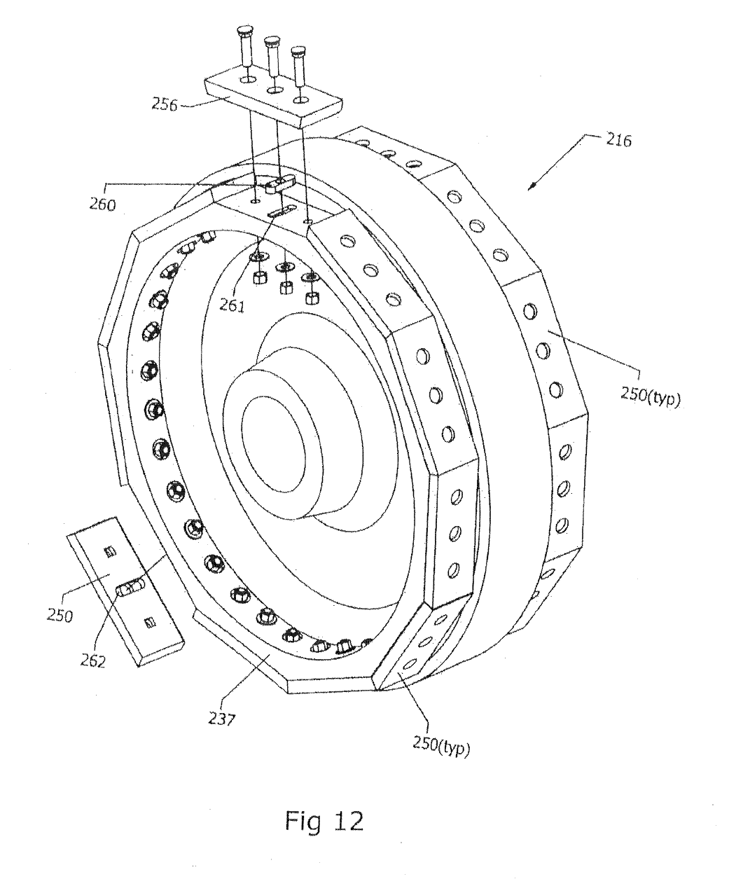

FIG. 13 is a side elevation of the idler of FIG. 11 incorporating one set of wear plates with a new track chain engaged therewith;

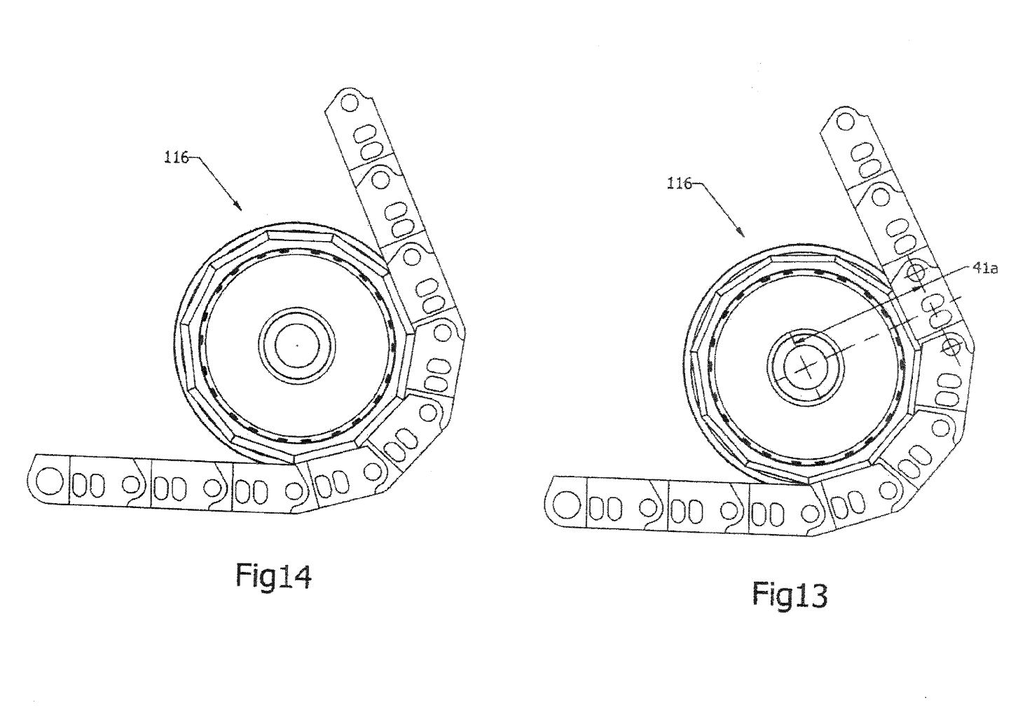

FIG. 14 is a side elevation of the idler of FIG. 11 incorporating a thicker set of wear plates with a worn track chain engaged therewith;

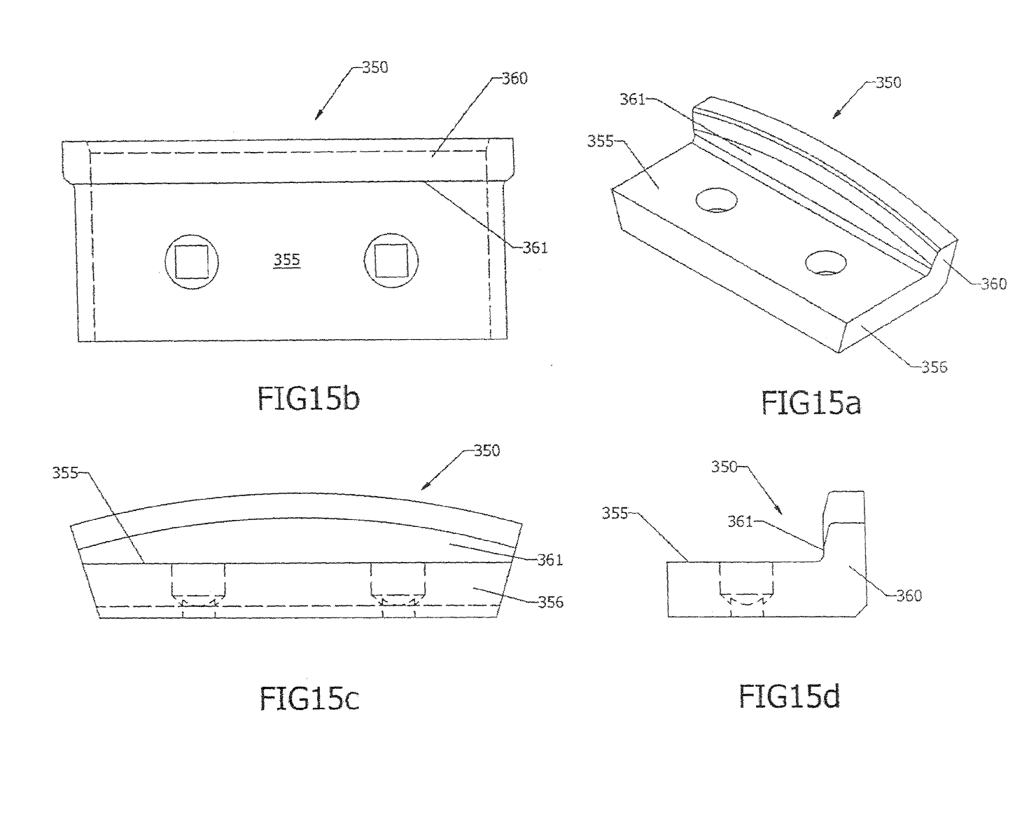

FIG. 15A is a pictorial representation of a wear plate according to the invention;

FIG. 15B is a plan of the wear plate of FIG. 15A;

FIG. 15C is a side elevation of the wear plate of FIG. 15A;

FIG. 15B is an end elevation of the wear plate of FIG. 15A;

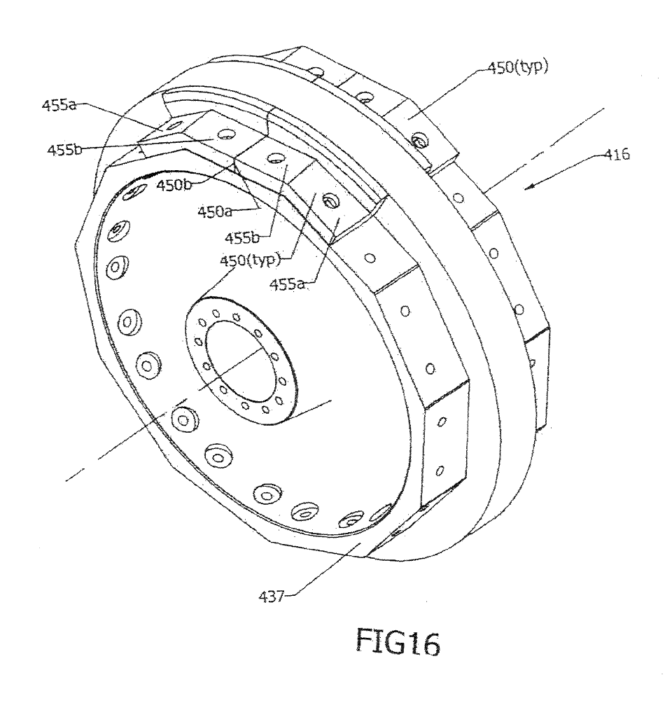

FIG. 16 is a pictorial representation of still another idler according to the invention; and

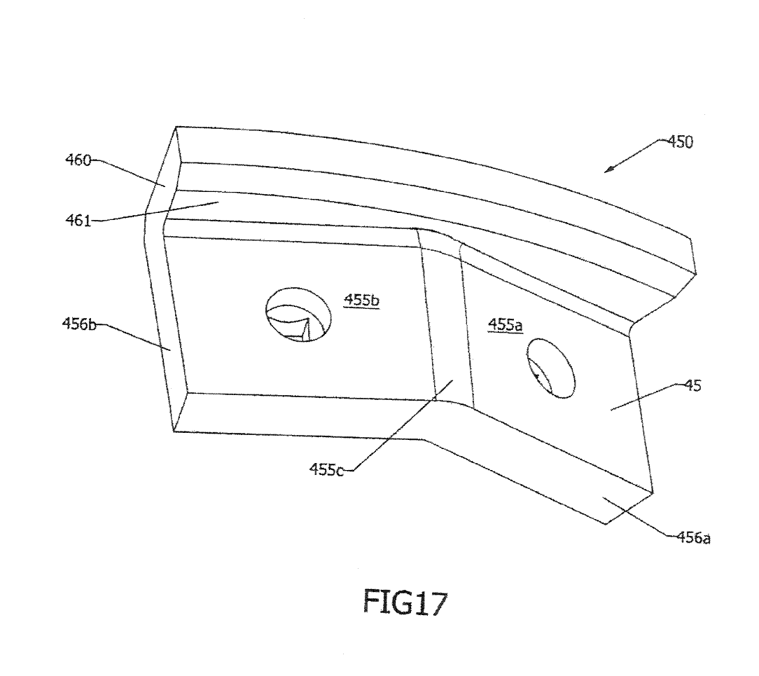

FIG. 17A is a pictorial representation of another wear plate according to the invention.

The bulldozer 10 illustrated in FIG. 1 includes a drive train 11 incorporating a conventional drive sprocket 12, a conventional front idler 13, a conventional track chain 14 and a rear idler 16 constructed according to the present invention as well as various other components which are well known as will be referred to from time to time. The front idler is mounted on a shaft 17 via bore 18 provided in its hub 19 for rotation relative thereto about axis 20 and the rear idler is similarly mounted on shaft 21 via bore 22 in its hub 23 for rotation relative thereto about axis 24 as can be seen more clearly in FIG. 2 and a plurality of ground engaging shoes or plates 25 are bolted to the links in known manner. While the bulldozer is shown with a conventional front idler, an idler with planar link supporting lands can also be used at the front as well as the rear or at any other appropriate place in a drive chain if desired.

As can be seen more clearly in FIG. 2, the track chain comprises chain halves 14a on the inside and 14b on the outside when looking at the side of the bulldozer. The chain halves each comprise a plurality of interconnected links 27 and 28 on the inside half and outside half respectively with the links on the two halves being aligned laterally and connected by pins and bushes 29 and 30 respectively as is well known. The bushes are adapted to be engaged by the teeth 12a of sprocket 12 for pulling the track around the idlers and the other running gear which includes rollers 31, bogies 32 and guides 33 as is well known, so as to propel the bulldozer forward or backwards as required.

Each of the links 27 and 28 has a top face 31 and a bottom face 32 when seen in the top chain run between the sprocket 12 and the front idler 13. It will be appreciated that as the sprocket pulls the chain around the track frame, the idlers and the rollers roll along the bottom face (which is on top of the links as it lies on the ground) to propel the dozer forwards or backwards as required.

As can be partly seen in FIG. 2, the two chain halves engage the front idler on two cylindrical chain supporting faces 13a and 13b on rim 36 which are spaced apart by a cylindrical center portion 13c of greater diameter which prevents the track running off the idlers by engagement with the respective inner side faces of the links of the two chain halves against the opposed shoulders 13d and 13e of the centre portion. It will be appreciated that the generally planar bottom faces of the chain links engaging the cylindrical link supporting faces 13a and 13b will be subject to more slippage than desired and the slippage will result in the links wearing at the mid-portion of their bottom faces more than at the end portion of their bottom faces with the result that the rollers 31 will suffer from up and down rolling forces due to the resulting arcuate form of the bottom faces of the chain links. However, it will also be appreciated that the front idler is subject to lesser load forces. (in most cases) than the rear idler due to the pushing forces from the dozer blade or rear rippers. Thus, the rear idler wears much more quickly than the front idler and causes wear on the chain links at a much greater rate than the front idler.

The rear idler 16 which as previously noted is constructed according to the present invention has a rim 37 which instead of having cylindrical chain supporting faces as does the front idler, has polygonal prismatic faces 16a and 16b respectively which are spaced apart by a cylindrical center portion 16d of greater diameter for preventing the chain from running off the idler by engagement of the inside faces of the chain against the shoulders 16d and 16e in much the same manner as with the front idler. In this case, each prismatic face 16a and 16b is made up of eleven generally planar link supporting lands 16f on one side and 16g on the other. Each land is of substantially equal length in circumferential direction (marked as item 41 in FIG. 8 and substantially the same width in the axial direction marked as item 42 in FIG. 9). The length 41 is selected according to a relationship between the link pitch of the chain and the radius of the dedendum circle as shown in FIG. 10. In this respect, it has been found that the length of the link supporting lands has a bearing on wear rate and the length should be about 80% of the link pitch although it may vary depending on the particular type and model of machine and the number of lands selected will depend on other parameters such as machine clearance. Idler 16 has eleven link supporting lands for a chain link length of 317.5 mm.

Although idler 16 has been cast with eleven planar link supporting lands forming each chain supporting face, the invention allows for the use of wear plates as shown in FIGS. 11 to 14, to form each chain supporting face as will now be described.

The idler 116 shown in FIG. 11A is the same as idler 116 previously described in most respects and has a hub 123 which is adapted to be mounted on the support shaft 21 via bore 122 for rotation relative thereto about the hub and shaft axes 124 and 24 respectively. The idler has a rim 137 of smaller inside and outside diameter than rim 37 with the same number of lands cast thereon, each land being of shorter length in the circumferential direction than the lands on the idler 16 and the lands being for the purpose of supporting thereon wear plates 150. Two bolt holes 151 and 152 extend through the rim in each land and are adapted to receive therethrough mounting bolts 153 and 154 respectively to secure the wear plates to the rim.

The outer surface 155 of each wear plate forms a planar link supporting land on which the track chain engages the idler in much the same manner as described in relation to idler 16. As can be seen in FIG. 11A, the ends 157 and 158 of each wear plate taper outwardly away from the rim, the angle of the taper being the angle enclosed by the length of the link supporting land on the wear plate which in this case is one eleventh of 360 degrees, there being eleven wear plates and thus eleven link supporting lands on each polygonal chain supporting face, the enclosed angle between adjacent lands being 32.7 degrees.

The idler 216 illustrated in FIG. 12 differs from that shown in FIG. 11A in that each wear plate 250 includes an additional bolt hole and a removable key 260 which is located for engagement in complementary key slots 261 and 262 provided in the rim 237 and wear plates 250 respectively to assist in properly locating the wear plates during fitting.

The wear plate 350 illustrated in FIGS. 15A to 15D is similar in many respects to the wear plates 150 included in idler 116 but each wear plate has a support section 356 with one face providing the link supporting land 355 corresponding to link supporting land 155 in wear plate 150 and also a guide section 360 extending therefrom and providing a link guide land 361 which is generally orthogonal to the link supporting land. Advantageously, the side faces of the chain links engage against the guide lands and when the wear plates are replaced, the new wear plates can accommodate side wear in the links by having a thicker guide section.

The idler 416 illustrated in FIG. 16 is similar in most respects to the idlers 116 and 216 shown in FIGS. 11A and 12 respectively but it differs in that it includes a plurality of wear plates 450 more clearly illustrated in FIG. 17, each of which has two contiguous support sections 456a and 456b, the respective upper surfaces of which form adjacent generally planar link supporting land portions 455a and 455b which meet at corner 455c, the two portions enclosing therebetween an angle of 32.7 degrees in this case (there being eleven link supporting lands on the idler). Suitably, as can be seen in FIG. 16, the wear plates are fitted to the idler rim 137 with end 450a of one plate abutting the opposite end 450b of the adjacent plate such that adjacent land portions 455a and 455b together make up a full link supporting land. Advantageously, each wear plate 450 also has a guide section 460 providing a link guide land 461 which is generally orthogonal to the link supporting land portions.

It will be appreciated that in use as the wear plates wear, the bottom faces of the chain links also wear but the provision of generally planar link supporting lands result in a wear pattern on the bottom face of the links which is much less arcuate (if not generally planar) than occurs with the cylindrical chain supporting faces of prior art idlers.

It has been found that heavy earth moving machinery can accommodate a certain amount of wear in the track chain links. Advantageously, wear of the chain links in a more planar manner allows replacement of the wear plates on the idler 116 by thicker wear plates to make up for wear of the chain links thus increasing the chain life as well as maintaining the desired overall measurement 41a as can be seen in FIG. 10. In this respect as will be appreciated from FIGS. 4E, 4F, 10, 11A and 11B, that as a set of wear plates and chains wear, the dimension 41a as seen in FIGS. 10 and 11B decreases with the length of the link supporting land decreasing and the height of the links also decreasing and the radius of the pins and bushes from the axis of the idler also decreasing which cause some amount of desynchronisation of the components which in turn results in a greater wear rate and uneven wear patterns. The present invention provides the opportunity of resetting overall measurement 41a by replacing a worn set of wear plates by a set having a thicker link supporting section (156, 256, 356, 456) than the original set so as to take up the wear shortfall of the original plates as well as the wear shortfall of the chain links.

As can be seen in FIGS. 4E and 4F, the length of the bottom face of each link increases from the length shown as item 43a to 43b as the links wear from an original height shown as dimension 63 to a lesser worn height shown as dimension 64 due to the end tapers 61 and 62. Correspondingly, the length of the link supporting land 155, 255, 355 and 455 will be greater on wear plates of greater supporting section thickness due to the end tapers of the wear plates, thus generally maintaining the desired correlation between the length of the bottom face of the chain length and the length of the link supporting lands as will be appreciated from FIGS. 13 and 14.

The use of removable wear plates enables worn wear plates to be removed from the idler rim and replaced by thicker wear plates in the field without removing the chain. In this respect, it will be appreciated from FIG. 1 that a number of planar lands on the rear idler are accessible between the top and bottom chain runs and idlers with wear plates will be accessible in a similar manner allowing two or three plates to be removed and replaced followed by a further two or three upon moving the bulldozer forward or back and so on. In cases where the chain has to be replaced, the wear plates and the chain can be replaced without removing the idlers.

Those skilled in the art will appreciate that the present invention may be susceptible to variations and modifications other than those specifically described. It will be understood that the present invention encompasses all such variations and modifications as would be understood by a person skilled in the art.

The invention claimed is:

1. A drive train for a tracked vehicle, the drive train including at least one drive sprocket, at least one idler and one or more track chains, each of said one or more track chains including a plurality of links pivotally connected to each other and adapted for engagement with said at least one drive sprocket and adapted to wrap around said at least one idler for movement therewith, at least one of said at least one idlers having a bore or hub for mounting the idler on a shaft for rotation relative thereto about the bore or hub axis and one or more chain supporting faces radially spaced from said bore or hub, the or each chain supporting face comprising a plurality of generally planar link supporting lands together forming a polygonal prismatic face coaxial with the hub axis, the link supporting lands being of substantially equal length in the circumferential direction and the bottom face of adjacent following links being arranged in use to engage adjacent lands of the same chain supporting face.

2. A drive train according to claim 1 wherein each link has a bottom contact face of a predetermined length and the length of each link supporting land is substantially the same as said predetermined length.

3. A drive train according to claim 1, wherein the link supporting lands are of substantially equal width in the axial direction.

4. A drive train according to claim 1, wherein said idler includes a plurality of detachable wear plates and said link supporting lands are formed on said detachable wear plates.

5. A drive train according to claim 4, wherein each link supporting land is formed on a single wear plate.

6. A drive train according to claim 4, wherein part of each link supporting land is formed on one wear plate and part on an adjacent wear plate.

7. A drive train according to claim 6, wherein the part of each link supporting land on adjacent wear plates is about half of each land.

8. A drive train according to claim 4, wherein said wear plates are adapted to be secured to the idler hub by bolts or similar fasteners engaging each planar face.

9. A drive train according to claim 4, wherein said wear plates have link guide lands generally orthogonal to the link supporting lands which are adapted to be engaged by faces of the chain links orthogonal to said bottom faces.

10. A drive train according to claim 1, wherein said one or more track chains comprises two spaced apart chain halves with the corresponding links of said chain halves being aligned laterally and connected by pins and bushes adapted to engage the drive sprocket and said one or more chain supporting faces comprising two spaced apart chain supporting faces and one of said chain halves is adapted to engage with one chain supporting face and the other track chain is arranged to engage with the other chain supporting face.

11. A drive train according to claim 10, wherein said idler has a cylindrical face coaxial with and between said two spaced apart chain supporting faces.

12. A drive train according to claim 11, wherein each of said chain supporting faces is separated from said cylindrical face by a shoulder.

13. A drive train according to claim 12, wherein each of said chain links has an inside face which is adapted to slidingly engage said shoulder.

14. A drive train according to claim 13, wherein said cylindrical face is spaced from said bore or hub axis by a distance greater than that of said chain supporting faces.

15. An idler for a tracked vehicle, the idler having a bore or hub for mounting the idler on a shaft for rotation relative thereto about the axis of the bore or hub and one or more chain supporting faces radially spaced from said bore or hub, each chain supporting face comprising a plurality of generally planar link supporting lands together forming a polygonal prismatic face coaxial with the bore or hub axis, the link supporting lands being of substantially equal length in the circumferential direction and the angle enclosed by adjacent link supporting lands being greater than one hundred and twenty degrees.

16. An idler according to claim 15, wherein said one or more chain supporting faces comprises two spaced apart chain supporting faces one chain supporting face being adapted to engage with one track chain half and the other being adapted to engage with another track chain half.

17. An idler according to claim 16, having a cylindrical face coaxial with and between said two spaced apart chain supporting faces.

18. An idler according to claim 17, wherein each of said chain supporting faces is separated from said cylindrical face by a shoulder.

19. An idler according to claim 18, wherein each of said chain links has an inside face which is adapted to slidingly engage said shoulder.

20. An idler according to claim 19, wherein said cylindrical face is spaced from said bore or hub axis by a distance greater than that of said chain supporting faces.

21. An idler according to claim 15 wherein the number of said plurality of generally planar link supporting lands is from six to twelve.

22. An idler according to claim 15 including a plurality of wear plates and wherein said link supporting lands are formed on said wear plates.

23. An idler according to claim 22 wherein said wear plates are detachably mounted on a rim or hub.

24. An idler according to claim 23 including keying means between the wear plates and the rim or hub for locating the wear plates relative to the rim or hub.

25. An idler according to claim 23 wherein said rim or hub includes a plurality of mounting faces corresponding with the number of wear plates against which said wear plates engage.

26. An idler according to claim 25 wherein said mounting faces are adapted to selectively receive sets of wear plates of different thickness.

27. A superset of wear plates for an idler, the superset including at least two sets of wear plates, the wear plates having a mounting face adapted to engage a supporting face of an idler hub to which the wear plates are to be attached and a chain link supporting land spaced from the mounting face, the distance between the mounting face and the chain link supporting land of the wear plates in a set being the same and the distance in at least one set being greater than the distance in another set, the increased distance being selected to compensate for wear in the track links which engage the wear plates when mounted to the same idler hub.

28. A superset of wear plates for an idler, the superset including at least two sets of wear plates, the thickness of the wear plates in a set being the same and the thickness of at least one set being greater than the thickness in another set the increased thickness being selected to compensate for wear in the track links which engage the wear plates.

29. A wear plate for an idler, the wear plate having two generally planar faces enclosing an angle therebetween greater than about one hundred and twenty degrees and adapted to be engaged in use by a track chain, the wear plate including securement means on or adjacent at least one of said faces for securing the wear plate to an idler.

30. A wear plate according to claim 29 wherein each planar face is adapted to form a portion of a link supporting land such that the adjacent planar faces of two adjacent wear plates on an idler hub together form a full link supporting land.

31. A wear plate according to claim 29 wherein each planar face forms about half the desired link supporting land.

32. A wear plate according to claim 29 including a link guide land generally orthogonal to the link supporting lands.
